(19) United States
(12) Patent Application Publication
(10) Pub. No.: US 2019/0095751 A1
(43) Pub. Date: Mar. 28, 2019

(54) PATTERN MATCHING

(71) Applicant: SYMBOL TECHNOLOGIES, LLC, Lincolnshire, IL (US)

(72) Inventor: Duanfeng He, South Setauket, NY (US)

(21) Appl. No.: 15/714,832

(22) Filed: Sep. 25, 2017

(51) Int. Cl. G06K 9/62; G06K 9/20

(52) U.S. Cl. CPC G06K 9/6206; G06K 9/20; G06K 9/623

(57) ABSTRACT

A method and apparatus for verifying a pattern by mapping a grid onto a template that defines a plurality of grid sections. A digital image may be taken of a container showing an identifying mark (or lack thereof). The template and/or grid may be scaled and/or translated to match a perspective of the identifying mark as depicted in the digital image. A correlation function compares individual grid sections to portions of the digital image to find portions that maximize a correlation score. Grid sections with low contrast may be skipped and/or combined with higher-contrast sections to compute a score. If a match condition is satisfied between at least some of the grid sections and the digital image of the identifying mark, the pattern has been verified.

### BACKGROUND OF THE INVENTION

Validating the provenance of an object may be accomplished by matching a pattern on the object, such as a logo or trademark, with a template. If a digital image is taken of the object for purposes of matching a pattern thereon, imperfections in the digital image may prevent accurate pattern matching. Commonly encountered imperfections in digital images include blur, rotation, noise, stretching, or compression.

Accordingly, there is a need for fast, efficient pattern matching that may have improved tolerance of imperfections commonly found in digital images of an object.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a template of an identifying mark and a digital image of the identifying mark on a container in accordance with some embodiments.

FIG. 2 is a diagram of a translated template of an identifying mark divided into grid sections in accordance with some embodiments.

FIG. 3 is a diagram of a correlation function comparing grid sections of a template to a digital image of an identifying mark.

FIG. 4 is a diagram of a second pass of a correlation function comparing grid sections of a template to a digital image of an identifying mark.

FIG. 5 is a schematic diagram of a device for validating the provenance of a consumable good using a correlation function applied to combined grid sections of a template and a digital image of an identifying mark.

FIG. 6 is a flowchart of a method of verifying a pattern in accordance with some embodiments.

FIG. 7 is a flowchart of an example correlation function in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In some implementations, the disclosure herein includes a method of verifying a pattern comprising mapping a grid onto a template, the grid dividing the template into a plurality of grid sections; capturing a digital image of an object. The method further may include applying a correlation function to at least some of the plurality of grid sections, the correlation function comparing one of the plurality of grid sections to a respective portion of the digital image of the object, the correlation function further outputting a correlation score of each of the at least some of the plurality of grid sections. The method may further include determining a correlation level between the template and the digital image of the object, the correlation level being based at least in part on the correlation score of each of the at least some of the plurality of grid sections; and verifying the object if the correlation level satisfies a match condition.

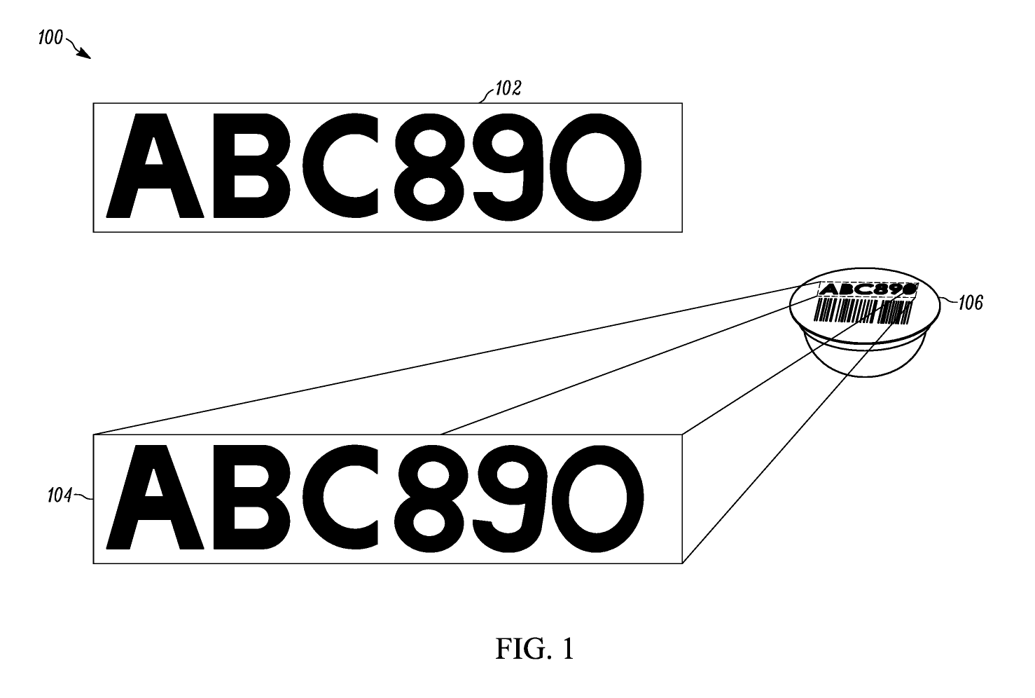

FIG. 1 is a diagram 100 of a template 102 of an identifying mark and a digital image 104 of the identifying mark on a container 106 in accordance with some embodiments. In some implementations, the template 102 represents an identifying mark that may be found on a physical object, such as the packaging of a consumable consumer good. The template 102 may include text, images, symbolic data, etc., expressed in a 2-dimensional format. The template 102 may include text characters with parameters including font, size, spacing. The identifying mark may be a trademark indicating the provenance of a good on which the identifying mark is printed.

Digital image 104 is an image of at least a portion of the container 106 including an area of the container where there is expected to be an identifying mark. The digital image 104 may be captured by an image sensor positioned near an area of the container 106 displaying the identifying mark. If a container is lacking an identifying mark matching the template 102, then the digital image 104 may include the absence of an identifying mark. Since the quality and other characteristics of the digital image 104 depend on a variety of factors which may change depending on conditions surrounding the digital image sensor, the digital image 104 may suffer from certain imperfections including blur, noise, rotation, zoom (e.g., stretching, compression), etc. The identifying mark, as depicted in the digital image, may be partly larger than the template in some areas and yet in other areas smaller than the template due to distortion caused by an imperfect lens. With respect to rotation, the digital image 104 may be at least slightly rotated compared to the reference template 102 due to imperfect alignment of the container 106 with respect to the digital image sensor. With respect to zoom, the digital image 104 may have a size that is not equal in size to the reference template 102 due to a distance between the image sensor and the container 106 that may be different from the designed for value. In at least one implementation, a distance between the container 106 and the digital image sensor need not be carefully controlled and may vary by several factors in comparison to a size of the reference template 102. The digital image 104 may also include a skew angle distorting the identifying mark to a degree due to an incident angle between the digital image sensor and a plane of the 2-D identifying mark.

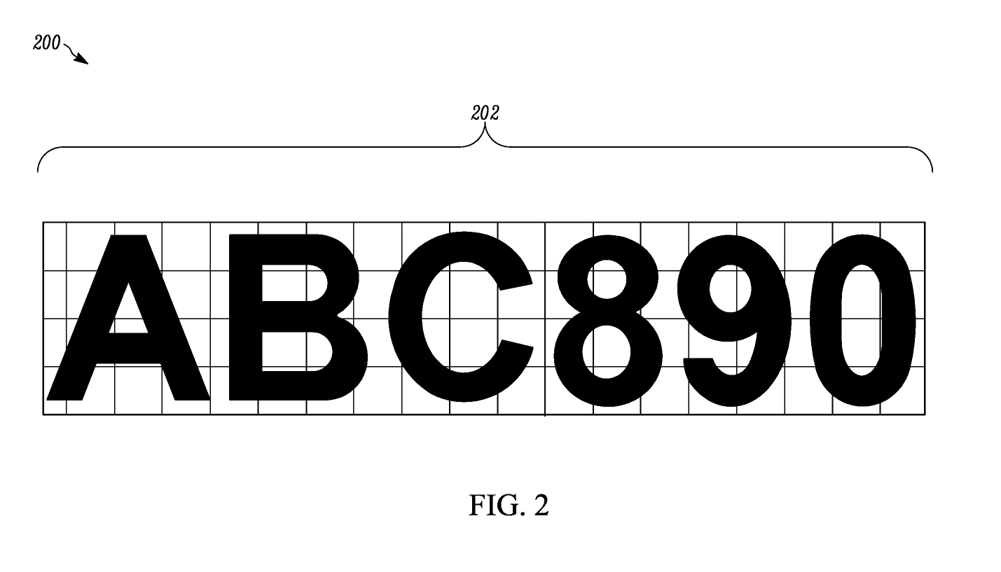

FIG. 2 is a diagram 200 of a translated template 202 of an identifying mark having a grid mapped thereon. The mapping of the grid divides the identifying mark into a plurality of grid sections 204 in accordance with some embodiments. The template may be translated in a number of manners. The template 202 may be zoomed up or down to match a reference size. In some implementations, the template 202 may be zoomed to match a size of a digital image of an object on which there may be an identifying mark to be matched to the template. In some implementations, zooming the template may preserve the aspect ratio of the template. Due to the relative shapes of the template and the digital image, it may not be possible to scale the template to the same size and shape as the digital image while preserving the aspect ratio. A differently sized template and digital images may therefore be used. Alternatively, or additionally, the template 202 may be translated by introducing a perspective skew angle transformation. In some implementations, the skew angle is chosen to match an expected skew angle between a digital image sensor and a portion of a container expected to include an identifying mark.

The translated template 202 is divided into a grid pattern defining a plurality of grid sections. The grid pattern may be a block pattern including rows and columns of blocks. The grid pattern need not consist of equal sized divisions or even horizontal and vertical components. In other words, the pattern may be horizontal stripes, vertical columns, and combinations thereof, or other sizes and shapes. Grid sections defined by the grid pattern may be all of equal size and shape or there may be of different sizes and shapes. Grid sections defined by the grid pattern may be overlapping or non-overlapping. In some implementations there are gaps between grid sections, meaning that certain parts of the template are not verified in the algorithm. In some implementations, the grid sections are non-overlapping and are approximately squared in shape. Several examples of individual grid sections are shown in bold outline in FIG. 2. The bolded grid sections are merely examples of individual grid sections chosen from all the grid sections in the template 202 for purposes of illustration.

Some of the individual grid sections in the template 202 may appear to be smaller than other grid sections (e.g., grid sections in the leftmost column). There may be no need to save full sized grid sections for all grid sections depending on the characteristics of the identifying mark (e.g., if a portion of a grid section or group of grid sections lacks contrast). In particular, embedded systems tend to present resource constraints, and a subset of smaller grid sections may save on valuable memory resources. In some implementations, grid sections that are smaller than other grid sections may be assumed to be the same size, with all white pixels constituting the “missing” part of the smaller grid sections.

The grid pattern may be chosen to select for different optimizations. For example, non-overlapping blocks may be higher efficiency, overlapping grid sections may be able to detect more pattern matches, more grid sections may reduce a number of low-contrast grid sections but require more computing resources, etc. In some implementations, a grid pattern is zoomed in and/or out and moved about horizontally and vertically until conditions are satisfied (e.g., until the number of low contrast grid sections is reduced below a threshold, etc.).

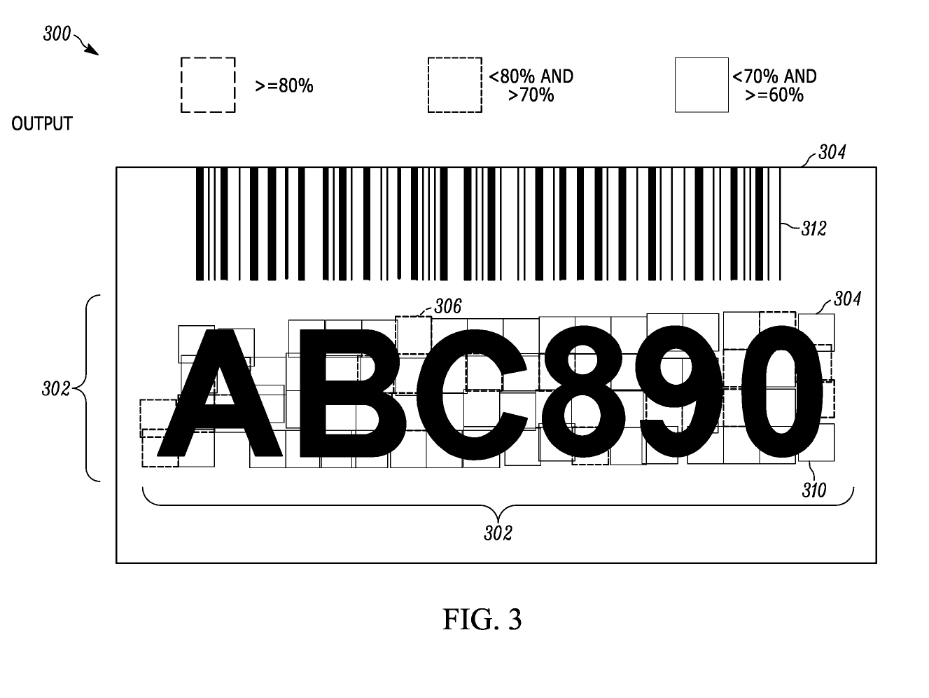

FIG. 3 is a diagram 300 of the application of a correlation function comparing the sections of a grid 302 mapped onto a template to a digital image 304 of an identifying mark. The correlation function matches individual grid sections of the grid 302 to respective portions of a digital image 304 of an identifying mark. In other words, each individual grid section of the grid 302 may be matched to a portion of the digital image 304 that is unique in comparison to other individual grid sections or that has some overlap with other sections 302 of the grid. As shown in FIG. 3, the grid sections are divided into rows and columns, the entirety of which is referred to herein as the grid. Some individual sections in the grid 302 are separately numbered herein for explanatory purposes. Individual grid sections may be shown in FIG. 3 as partially matching respective portions of the digital image. In other words, the location of an individual grid section 302 may be shown as fitting a best match against respective portions of the digital image or illustrated as a fit as less than a best match against respective portions of the digital image. The best match of individual grid sections is illustrated in the example of FIG. 3, with individual grid sections of less than 80% match in dashed lines (e.g., individual grid section 306), individual grid sections of more than 80% match in solid lines (e.g., individual grid section 308), and individual grid sections that fail to match above a threshold, also referred to herein as “unmatched” grid sections, without border lines (e.g., individual grid section 312).

In at least one implementation, the template is translated (e.g., zoomed, moved, etc.) to improve the matching process based on a barcode 310 in the digital image of the identifying mark. A barcode 310 may provide the scale, orientation, and relative location of the identifying mark. If it is assumed that the barcode and the identifying mark are in the same spatial plane (e.g., if the identifying mark and the barcode are both printed on a side of a container), then a deviation of the barcode 310 from a known space, rectangle with certain aspect ratio, etc., can help establish a mathematical model for a homography mapping the image pixels to a model space which is substantially or entirely free of perspective distortion. The homography mapping may be applied to the template to align the template more closely with the identifying mark as depicted by the digital image. Alternatively, the homography mapping may be applied to the digital image to align it more closely with the template.

The various individual grid sections of the grid pattern 302 may be assigned individual correlation scores according to the output of a chosen correlation function. In at least one implementation, the correlation function outputs a correlation score for each of the matched grid sections. In some implementations, the correlation function is a matched filter and match scores range from −100% to 100% where 100% is an exact match (e.g., a pixel-for-pixel match) and −100% is an exact reverse match (e.g., each white pixel is black and vise-versa) of a grid section in comparison to the best match found on a portion of the digital image 304.

One type of correlation function that may be used in a matched filter may be a normalized cross-correlation defined as:

$$C ( f , g ) = \frac{\sum ( f - \overline{f} ) ( g - \overline{g} )}{\sqrt{\sum {( f - \overline{f} )}^{2}} \sqrt{\sum {( g - \overline{g} )}^{2}}}$$

wherein g is a 2D section of the grid template, f is a 2D section of the digital image with the same dimension as g, f̅ is the average value of the template within the 2D section, and g̅ is the average value of the image pixels within the corresponding 2D section, and the sum operations are performed over all members g.

In one aspect, the correlation function finds a best match between a grid section and a portion of the digital image 304. To find the best match, the correlation function is applied to various different portions of the digital image 304. In other words, the correlation function “floats” a grid section of the grid 302 with respect to the digital image until a best match is found according to the correlation function. A correlation score of the best match location is assigned to the respective grid section of the grid 302.

Best matches are found at a maximum value of the function C(f, g). C(f, g) is maximized by starting a grid section at an expected location with respect to a digital image. The grid section is moved about horizontally and vertically with a computation of C(f, g) at each discrete location of the grid section. The expected location may be derived with reference to a characteristic or landmark of the digital image (e.g., the barcode 310, etc.). An expected location for subsequent grid sections is derived from neighboring or adjacent grid sections for which a best match (e.g., a maximum of C(f, g)) has already been found.

Application of a correlation function to calculate correlation scores of the various grid sections of the grid 302 may be performed in an order on individual grid sections so as to increase efficiency of the correlation function calculation and to increase the odds of finding a portion of the digital image 304 that is a best match for any particular grid section, especially if a system can only devote enough resources to the correlation function operation such that it selects a best fit after only a limited number of iterations (e.g., if a correlation function does not test every possible portion of the digital image before selecting a “best” match for an individual grid section).

In at least one implementation, applying a correlation function scores individual grid sections starting with a beginning grid section. A beginning grid section may be chosen based on characteristics of the template to facilitate matching a grid section 302 of the grid early on such that applications of the correlation function to additional grid sections can be based on the early match.

In one example, a beginning grid section may be a grid section that includes one or more characteristics unique to said grid section (e.g., a grid section covers a portion of a template that includes features that are relatively easier to detect such as an edge or line extending across the grid section at an angle). The beginning grid section may be a grid section whose location is easy to predict, and which contains one or more corner features which are preferable for pattern matching. A corner feature may include a character or symbol with a border making a substantial change in direction at a point. A beginning grid section may be chosen at least in part on a contrast level of the grid section. Generally, grid sections with higher levels of contrast are easier to evaluate in the correlation function than grid sections with lower levels of contrast. A grid section with a higher level of contrast may therefore be more easily found and matched. In another implementation, a beginning grid section is chosen based at least in part on the grid section being close to or at the center of a digital image 304 of an identifying mark. If a system includes a digital image sensor in a fixed position relative to an object (e.g., a camera focused on a portion of a package having an identifying mark inserted into a machine), then a successful match in the digital image 304 would include an identifying mark occupying a certain portion of the digital image 304, which is less likely to be out of frame if the certain portion is nearer the center of the template (e.g., possibly after scaling the digital image 304 and/or the template to a substantially same size).

In another example, a beginning grid section is chosen from a relative location of a nearby identifiable object, such as a barcode. For example, one of the lower-left and lower-right corners of the barcode in FIG. 3 can be used, plus a known offset, to locate a nearby grid section. Alternatively, the midpoint between the lower-left and lower-right corners of the barcode can be used, again with a known offset, to find a beginning grid section.

Once a best match has been found for an individual grid section (e.g., a beginning grid section), the correlation function may be applied to other neighboring or adjacent grid sections. Adjacent grid sections may be viewed as being “bootstrapped” to a previously matched grid section because a matched on one grid section provides a clue about the location of neighboring grid section. For example, a grid section located directly below a beginning grid section may be said to have been bootstrapped to the beginning grid section if the correlation function is applied to the grid section directly below based at least in part on having matched the beginning grid section first. In some implementations, these grid sections are only allowed a limited amount of motion compared to their predicted locations, so that such motion could not make a grid section out of place in relation to the previously found locations of its neighbors. Such a limitation brings with it the additional benefit of reducing the amount of time to calculate the correlation values.

In at least one implementation, an order of applying the correlation function operates on the basis of a stack where the stack represents a queue of grid sections that the correlation function may operate on. Grid sections may be “pushed” on the stack when a best match has been found for an adjacent grid section and “popped” off the stack when the processor is ready to process the correlation function for another the grid section. The stack may operate according to a FIFO (first-in, first-out), FILO (first-in, last-out) manner, etc.

After the correlation function has been applied to some of the grid sections, a correlation level may be determined between the digital image 304 and the template. Various match conditions may be defined to determine whether a particular digital image 304 matches a template. In some implementations, a minimum number of grid sections 302 need to be matched at or above a minimum correlation score for a digital image 304 to be deemed to satisfy a match condition with a template. In another implementation, an average correlation score needs to be calculated across some or all of the grid sections of the grid 302 for a digital image 304 to be deemed a match with a template. In some implementations, a match condition is satisfied based on a variant form of average match rate for individual grid sections 302—the total number of matched grid section scores divided by the total number of grid sections. Since some grid sections may never be matched at all, particularly if the grid neighbors of the grid section themselves have low correlation scores, the variant form of average match rate can be lower than the true average of all the matched grid sections.

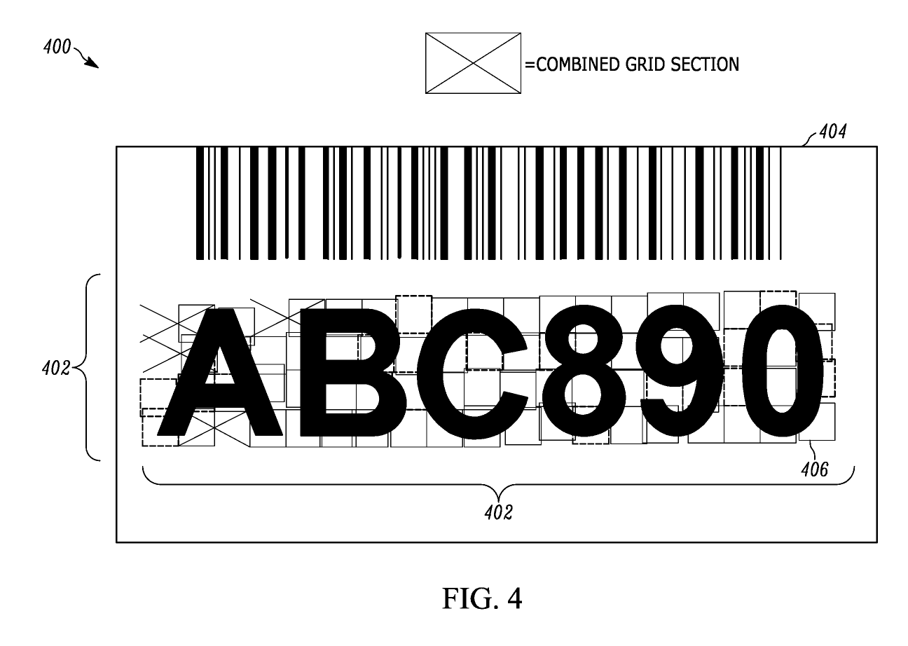

FIG. 4 is a diagram 400 of a second pass of a correlation function comparing grid sections of a grid template 402 to a digital image 404 of an identifying mark. In some implementations, after a first pass of applying the correlation function to the digital image, some grid sections will remain unmatched. A grid section may be unmatched when in the template most or all of the pixels are of the same color (white or black).

It may be said that unmatched grid sections satisfy a low-contrast condition, such as if the grid section is substantially or entirely uniform. In one example, a grid section wherein over 95% of pixels in a grid section share a pixel value satisfies a low-contrast condition. It may be difficult to apply the correlation function against low-contrast grid sections or the correlation function may give inaccurate results with respect to whether there is a match between the digital image and the template when applied to low-contrast grid sections.

In some implementations, the correlation function skips unmatched grid sections in a first pass and creates combined grid sections shown with the cross-pattern in FIG. 4 that include combinations of matched and unmatched grid sections. The combined grid sections including unmatched grid sections can be evaluated in a second pass of the correlation function. A grid section skipped on a first pass (also referred to as a “skipped grid section” or a “skipped section”) may be combined with any adjacent section or combination of adjacent sections to form a combined grid section (e.g., combined grid section 406). Combining the skipped grid section with an adjacent section that was matched in the first pass creates a larger grid section (e.g., combined grid section 406) that will satisfy a match condition (e.g., by increasing the amount of contrast in the combined grid section that contained the skipped grid section).

After a second pass of the correlation function is applied to combined grid sections, the digital image 404 may be evaluated or reevaluated to determine whether a correlation level of at least some of the evaluated grid sections satisfies a match condition. For example, if 80% of grid sections have a correlation score of 80% or above, then the correlation level may satisfy a match condition. In other examples, one or more grid sections with low correlation scores may be discarded before determining whether the match condition is satisfied. In other examples, a minimum number of grid sections having at least an 80% correlation score (or another chosen minimum correlation score) satisfies a match condition.

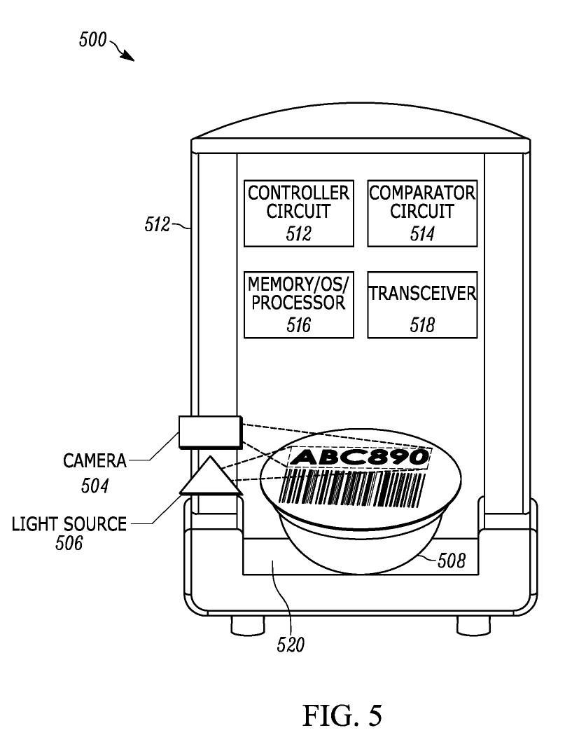

FIG. 5 is a schematic diagram of a device 500 for validating the provenance of a consumable good in a container 508 having an identifying mark 510. The device 502 includes a receptacle 520 for insertion of a consumable good in a container 508 (e.g., ground coffee beans, tea leaves, hot water, soft drink syrup, alcoholic drinks, etc.). The container may be a box, bottle, bag or other type of container including an identifying mark 510. In some implementations, the identifying mark may be a trademark or trade name used to identifying the provenance of the consumable good in the container 508. In another implementation, the container 508 may lack the identifying mark 510 and therefore will not match a template.

The device 500 includes a digital image sensor 504 disposed in the housing 502 of the device such that the identifying mark 510 of the container 508 is in view. The housing 502 of the device 500 may also include a light source 506 disposed such that an identifying mark 510 on a container 508 inserted into the receptacle 520 is illuminated. The light source 506 may be either an active (e.g., LED, bulb, etc.) or passive (e.g., merely an optical pass-through in housing 502) light source. The light source 506 may include one or more openings in the housing 502 such that the digital image sensor 504 is capable of capturing a digital image of the portion of the container 508 including the identifying mark 510. The light source 506 may be inside or outside of the spectrum of light visible to humans.

The device 500 includes a comparator circuit to apply a correlation function to at least some of a plurality of grid sections dividing a template and some portion of a digital image taken by the digital image sensor 504 of the identifying mark 510 on the container 508. In some implementations, the correlation function outputs a correlation score (e.g., a best match of a grid section against selected portions of the digital image of the identifying mark 510) of each of the individual grid sections against some portion of a digital image taken by the digital image sensor 504 of the identifying mark 510. The comparator circuit is further configured to determine a correlation level between the template (e.g., at least some matched grid sections of the template) and the image of the object. If enough grid sections score high enough (e.g., a weighted score, a minimum score for a grid section to be considered matched, etc.) then the comparator circuit determines whether the digital image of the identifying mark satisfies a match condition.

The device 500 includes a controller circuit 512. The controller circuit 512 performs various functions of the device 500. In at least one implementation, the controller circuit rejects the container 508 if a match condition has not been determined to exist by the comparator circuit 514. For example, the controller circuit 512 may eject the container 508 out of the receptacle 520, display a message to a user that the provenance of the consumable good in the container 508 has not been successfully matched, refuse to process the consumable good in the container 508, etc. The controller circuit 512 may further interface with other components of the device 500, including a memory/OS/processor 516 and/or a transceiver 518 to perform any of the functions described herein and/or to communicate data with other devices (e.g., transmitting the digital image captured by the digital image sensor 504 to another device to determine whether a match condition is satisfied, alerting another component if a match condition has/has not been satisfied, etc.).

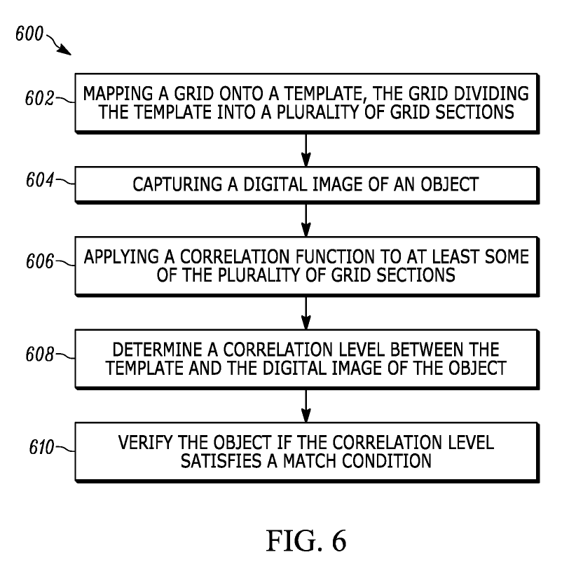

FIG. 6 is a flowchart of a method 600 of verifying a pattern in accordance with some embodiments. A mapping operation 602 maps a grid onto a template, the grid dividing the template into a plurality of grid sections. The grid sections need not be strictly speaking arranged in a grid with rows and columns. By grid section it is meant any division of the plane of the template into sections, whether the sections are all the same size and shape or not (e.g., regular tessellation, irregular tessellation, non-tessellation, etc.). The grid sections may cover at least those sections of a template that provide contrast on which to base a correlation function. The number of grid sections may be determined based on whether enough of the grid sections include a minimum level of contrast on which to base a correlation function. In at least one implementation, the number of grid sections is scaled in or out (e.g., the grid is zoomed in or out) to find a granularity of grid sections that will include enough grid sections without low contrast conditions.

A capturing operation 604 captures a digital image of the object. The digital image may include all or part of an object. The capturing operation 604 may be directed to a portion of an object on which it is expected that an identifying mark may have been deposited. For example, the capturing operation 604 may be directed to a portion of a container of a consumable good on which a trademark identifying the provenance of the good may have been printed.

An applying operation 606 applies a correlation function to at least some of the plurality of grid sections. The applying operation 606 compares a grid section to a portion of the digital image captured in the capturing operation 604. The applying operation 606 may include a beginning grid section located in an area of the template (e.g., the center of the template) that the applying operation 606 evaluates first before other grid sections. A beginning grid section may be chosen based on high contrast, central location in the template, etc.

The applying operation 606 may proceed to determine a correlation score for some of the grid sections in the plurality of grid sections mapped in operation 602. The applying operation may include a matched filter design defined as:

$$C ( f , g ) = \frac{\sum ( f - \overline{f} ) ( g - \overline{g} )}{\sqrt{\sum {( f - \overline{f} )}^{2}} \sqrt{\sum {( g - \overline{g} )}^{2}}}$$

wherein g is a 2D section of the grid template, f is a 2D section of the digital image with the same dimension as g, f̅ is the average value of the template within the 2D section, and g̅ is the average value of the image pixels within the corresponding 2D section, and the sum operations are performed over all members g.

In one aspect, the correlation function finds a best match between a grid section and a portion of the digital image 304. To find the best match, the correlation function is applied to various different portions of the digital image 304. In other words, the correlation function “floats” a grid section with respect to the digital image until a best match is found according to the correlation function. A correlation score of the best match location is assigned to the respective grid section.

The applying operation 606 may include more than one pass across grid sections in the plurality of grid sections. A first pass may skip grid sections with low correlation scores or with low contrast levels. A second pass of the applying operation 606 may combine any skipped grid sections into combined grid sections with grid sections that were not skipped in a first pass. For example, skipped grid sections may be combined with an adjacent grid section to create a double wide combined grid section.

A determining operation 608 determines a correlation level between the template and the digital image of the object. The determining operation 608 may be based on correlation scores of individual grid sections, on average scores of some grid sections (e.g., matched grid sections), whether a threshold number of grid sections satisfy a minimum correlation score, etc. A verifying operation 610 verifies the object if the correlation level satisfies a match condition. In some implementations, the verifying operation 610 permits on operation on a consumable good in a container based on the match condition being satisfied.

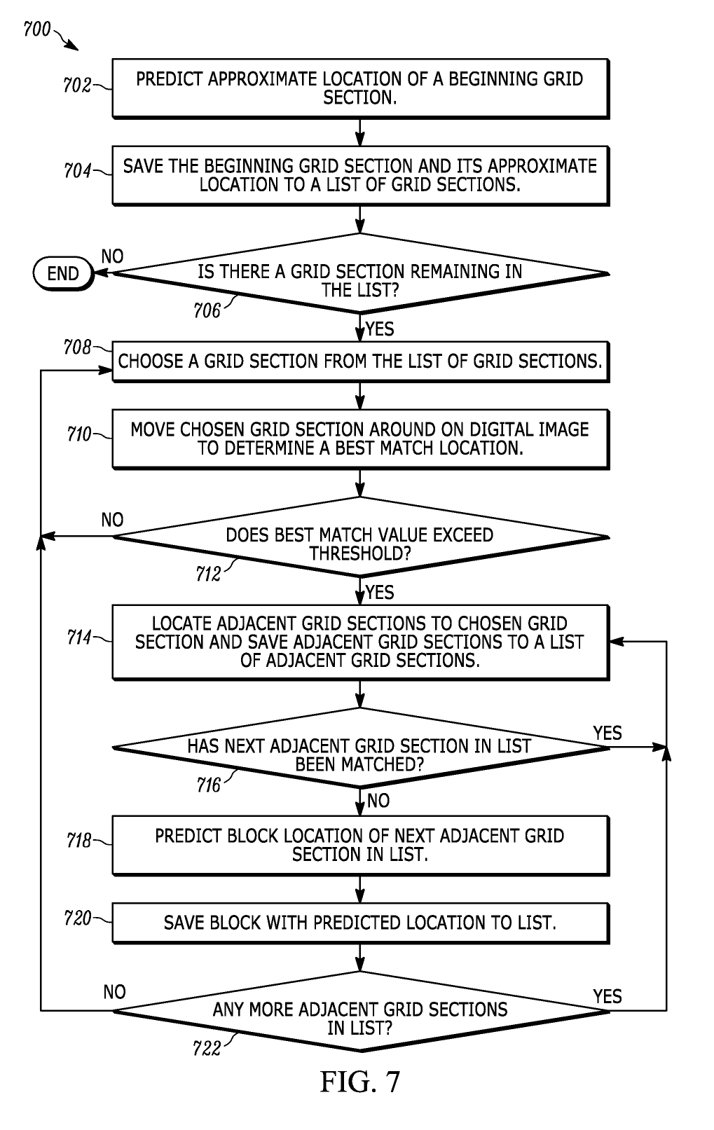

FIG. 7 is a flowchart of an example correlation function 700 in accordance with some embodiments. In some embodiments, the example correlation function 700 may be included in the applying operation 606 described with reference to FIG. 6. The example correlation function 700 includes a predicting operation 702 that predicts an approximate location of a beginning grid section. The predicting operation may be based on an expected landmark on the digital image such as a barcode or a feature of an identifying mark. A saving operation 704 saves the beginning grid section and its approximate location to a list of grid sections.

Starting at block 706, the correlation function 700 loops through the list of grid sections and corresponding approximate locations until the list is exhausted. If there is a grid section remaining in the list, the function 700 proceeds to a choosing operation 708. The choosing operation 708 chooses a grid section from the list of grid sections for a moving operation 710.

The moving operation 710 moves the chosen grid section around on a portion of a digital image to determine a best match location. In some implementations, the moving operation 710 includes finding a maximum value of a correlation function based on adjustments to the location of the grid section on the digital image. The grid section may be moved according to a discrete number of positional adjustments or the correlation function may be evaluated to find a maximum value based on a continuous evaluation of the function.

Once a best match has been determined for the grid section, block 712 determines whether the best match value exceeds a threshold. A threshold may be chosen to represent a minimum amount of correlation between the grid section and the portion of the digital image that has been found as the best match location for the grid section. Even if a grid section is a poor match for a portion of the digital image, some pixels may still match between the two, giving the grid section a non-zero score. These low but non-zero scores may be discarded by the correlation function by skipping the grid section. In some implementations, skipped grid sections are combined with adjacent grid sections.

If the best match value does exceed the threshold, then a locating operation 714 locates grid sections that are adjacent to the chosen grid section and saves the adjacent grid sections to the list of grid sections together with their respective approximate locations. Block 716 is a decision block based on whether the next adjacent grid section in the list been matched. If it has been matched, the correlation function 700 returns to the locating operation 714. If it has not been matched, the correlation function 700 proceeds to predicting operation 718. Predicting operation 718 predicts the location of the next adjacent grid section in the list and saving operation 720 saves the grid section predicted location to the list. Decision block 722 returns to block 706 is there are not more adjacent grid sections in the list and returns to locating operation 714 is there are more adjacent grid sections in the list.

Based on the above disclosure of correlation function 700, the correlation function 700 can be said to start with a beginning grid section and to “bootstrap” adjacent grid sections by predicting the location of the adjacent grid sections based on a best match location of the beginning grid section. As more best match locations are found for additional individual grid sections, more adjacent grid sections can be bootstrapped to the best match locations until the correlation function 700 has exhausted all grid sections in the template.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of verifying a pattern, the method comprising:
mapping a grid onto a template, the grid dividing the template into a plurality of grid sections;
capturing a digital image of an object;
applying a correlation function to at least some of the plurality of grid sections, the correlation function comparing one of the plurality of grid sections to a respective portion of the digital image of the object, the correlation function further outputting a correlation score of each of the at least some of the plurality of grid sections;
determining a correlation level between the template and the digital image of the object, the correlation level being based at least in part on the correlation score of each of the at least some of the plurality of grid sections; and
verifying the object if the correlation level satisfies a match condition.

2. The method of claim 1, wherein the applying operation includes repeatedly applying the correlation function to different respective portions of the digital image of the object to find a best match portion of the digital image of the object.

3. The method of claim 1, further comprising one of:
scaling the digital image of the object to a size of the template and scaling the template to a size of the digital image.

4. The method of claim 1, wherein at least some of the plurality of grid sections are overlapping.

5. The method of claim 1, wherein the correlation function includes the function:
$$C ( f , g ) = \frac{\sum ( f - \overline{f} ) ( g - \overline{g} )}{\sqrt{\sum {( f - \overline{f} )}^{2}} \sqrt{\sum {( g - \overline{g} )}^{2}}}$$
wherein g is a 2D grid section of the template, f is a 2D section of the digital image with the same dimension as g, and the sum operations are performed over all members of g.

6. The method of claim 1, wherein the applying operation includes determining a correlation score of a second grid section in the plurality of grid sections after a correlation score of a first grid section has been determined, the correlation score of the first grid section satisfying a bootstrapping condition and the first and second grid sections being adjacent.

7. The method of claim 1, further comprising:
evaluating a contrast level of each of the plurality of grid sections in the template; and
decreasing a number of the plurality of grid sections if the contrast level satisfies a low-contrast condition.

8. A system for verifying a pattern, the system comprising:
a camera positioned to capture an image of an object;
a comparator circuit configured to apply a correlation function to at least some of a plurality of grid sections dividing a template, the correlation function comparing one of the plurality of grid sections to a respective portion of the image of the object, the correlation function further outputting a correlation score of each of the at least some of the plurality of grid sections; and
the comparator circuit further being configured to determine a correlation level between the template and the image of the object, the comparator circuit further configured to verify the object if the correlation level satisfies a match condition.

9. The system of claim 8, wherein the comparator circuit is further configured to:
skip applying the correlation function, in a first correlation pass, to one of the plurality of grid sections if the one of the plurality of grid sections satisfies a low-contrast condition;
combine, in a second correlation pass, the one of the plurality of grid sections with an adjacent grid section into a combined grid section; and
apply, in the second correlation pass, a second correlation function to the combined grid section, the second correlation function comparing the combined grid section to another portion of the image of the object.

10. The system of claim 8, wherein applying, the correlation function includes a beginning grid section, the beginning grid section being located substantially near the center of the template, and the correlation level of the beginning grid section being determined before other grid sections in the plurality of grid sections.

11. The system of claim 8, wherein the plurality of grid sections are positionally shifted if some of the plurality of grid sections satisfy a low-contrast condition.

12. The system of claim 8, wherein the correlation score is based at least in part on a ratio of matching pixels to non-matching pixels between the one of the plurality of grid sections and the respective portion of the image.

13. The system of claim 8, The method of claim 1, wherein the correlation function includes the function:
$$C ( f , g ) = \frac{\sum ( f - \overline{f} ) ( g - \overline{g} )}{\sqrt{\sum {( f - \overline{f} )}^{2}} \sqrt{\sum {( g - \overline{g} )}^{2}}}$$
wherein g is a 2D grid section of the template, f is a 2D section of the digital image with the same dimension as g, and the sum operations are performed over all members of g.

14. The system of claim 8, wherein the comparator circuit is configured to determine the correlation score by repeatedly applying the correlation function to different portions of the image until a best match is found.

15. The system of claim 14, wherein the different portions of the image are chosen based on a rotation of a grid section with respect to the image of the object.

16. A system for verifying the provenance of a consumable good, the system comprising:
a receptacle for insertion of a consumable good, the consumable good having a container;
a light source positioned to illuminate the container when the consumable good is inserted into the receptacle;
a camera positioned to capture an image of at least a portion of the container when the consumable good is inserted into the receptacle;
a comparator circuit configured to determine a correlation level between the image and a template, the template being divided into a plurality of grid sections; and
a control circuit configured to reject the consumable good if the correlation level does not satisfy a match condition.

17. The system of claim 16, wherein the consumable good includes an input to a beverage.

18. The system of claim 16, wherein rejecting the consumable good includes displaying a message that the system accepts only consumable goods of a certain provenance.

19. The system of claim 16, wherein the correlation level between the image of the container and the template is determined at least in part by adjusting the position of some of the plurality of grid sections with respect to the image of the container.

20. The system of claim 16, wherein the correlation level between the image of the container and the template is determined by pushing grid sections adjacent to a matched grid section onto a stack and determining a correlation level for subsequent grid sections according to a position of the subsequent grid sections in the stack.
